(19) United States
(12) Patent Application Publication
(10) Pub. No.: US 2013/0186365 A1
(43) Pub. Date: Jul. 25, 2013

(54) PISTON, CYLINDER AND ENGINE WITH CROWN PRECISION COOLING

(71) Applicant: FRANZ J. LAIMBOECK, GOLETA, CA (US)

(72) Inventor: FRANZ J. LAIMBOECK, GOLETA, CA (US)

(73) Assignee: MAHLE KOENIG KOMMANDITGESELLSCHAFT GMBH & CO KG, RANKWEIL (AT)

(21) Appl. No.: 13/604,832

(22) Filed: Sep. 6, 2012

Related U.S. Application Data
(60) Provisional application No. 61/531,389, filed on Sep. 6, 2011.

(51) Int. Cl. F02F 3/00

(52) U.S. Cl. CPC F02F 3/00
USPC 123/193.6

(57) ABSTRACT

An engine piston has a connecting rod connected rigidly to the piston. At least one cavity is formed in the piston head, the cavity communicating in the region thereof close to the piston longitudinal axis with an oil supply line running through the connecting rod. The cavity is formed by a number of channels which run, preferably radially, in the piston head and are connected to one another in the circumferential region of the piston via an annular space or an annular line, and wherein a return line leading to the connecting rod is connected to the annular space or the annular line. The cavity or the channels forming the cavity and/or the return line are inclined at an angle of 1° to 4°, preferably 1° to 3°, to a plane perpendicular to the piston longitudinal axis.

### CROSS-REFERENCE TO RELATED APPLICATION

This application claims the benefit, under 35 U.S.C. §119(e), of provisional patent application No. 61/531,389 filed Sep. 6, 2011; the prior application is herewith incorporated by reference in its entirety.

### BACKGROUND OF THE INVENTION

1. Field of the Invention

The invention relates to an engine piston with a connecting rod connected rigidly to the piston. At least one cavity is formed in the piston head, the cavity communicating in the region thereof close to the piston longitudinal axis with an oil supply line running through the connecting rod. The cavity is formed by a number of channels which run, preferably radially, in the piston head and are connected to one another in the circumferential region of the piston via an annular space or an annular line. A return line leading to the connecting rod is connected to the annular space or the annular line. The invention furthermore relates to a cylinder comprising at least one engine piston of this type. Finally, the invention relates to an engine or to an opposed piston engine which has a cylinder in which two pistons according to the invention are arranged.

An engine piston of this type is known from Japanese published patent application JP 2009264143 3A. The channels in the piston head for the cooling fluid are inclined at an angle of approximately 15° with respect to the piston axis. Oil is returned via channels perpendicular to the piston axis.

### SUMMARY OF THE INVENTION

It is the object of the invention to construct an engine piston having a long service life at high rotational speeds. A cylinder comprising an engine piston of this type, like the piston per se, is intended to be able to be produced simply and cost-effectively and to suit all operating situations.

According to the invention, these objects are achieved in the case of an engine piston of the type mentioned above wherein the cavity or the channels forming the cavity and/or the return line are inclined at an angle of 1° to 4°, preferably 1° to 3°, to a plane perpendicular to the piston longitudinal axis.

With the objects of the invention in view there is also provided a cylinder with a connecting rod and a piston as described. The combustion-chamber-remote base region of the cylinder has a guide in which the connecting rod is mounted in a guided manner.

The engine piston designed according to the invention has oil cooling, which oil is supplied to the piston head and is transported away from the piston head by the acceleration or deceleration of the stroke movements of the piston. In the case of a piston according to the invention, a large throughput of oil for cooling the piston is possible. The oil which is transported away may be used for lubricating the crankshaft, or said oil is conducted into the crankshaft chamber for further use. The piston is efficiently cooled via the piston head, wherein the cooling is possible as far as into the border regions of the piston.

For example, the mass force at 4000 rpm and a stroke of 70 mm (angular velocity Omega 418 rad/sec) may amount to a deceleration of the order of magnitude of 6141 m/sec2 or 626 g (626 times the gravitational acceleration). The mass forces are therefore suitable for transporting oil to and away from the dead centers. However, the angle of inclination of the channels should also be taken into consideration, since this influences the exerted forces and the transported masses. Finally, the delivery force of the oil pump, which has to ensure a corresponding delivery of oil in spite of the forces which occur, has to be taken into consideration. Of most significance is the inclination of the channel with which the oil is conveyed into the piston head, since the desired cooling effect is thereby determined. Said effect can be reinforced by the inclination of the return channels without adversely affecting or interrupting the circulation of oil.

In terms of structure and cooling, it is advantageous if the cavity is formed by a number of channels which preferably run radially in the piston head, are optionally connected to one another, in particular in the circumferential region of the piston, preferably via an annular space or annular line, and/or branch in the piston head or are expanded toward the piston circumference, and/or if the cavity or the channels forming the cavity are connected in the circumferential region of the piston, optionally via at least one annular or collecting line running peripherally, to at least one return line leading to the connecting rod, and/or if the return line is connected to an oil return line guided in the connecting rod, and the cavity or the channels forming the cavity is or are located closer to the end surface of the piston than the return lines.

In order to configure the throughput of oil through the piston head by means of the stroke movements of the piston so as to be optimum and simple structurally, it can be provided that the oil supply line is guided centrally in the connecting rod, and/or in that the oil return line which is connected to the return line is arranged peripherally or eccentrically in the connecting rod and/or the piston is formed centrally and symmetrically with respect to the longitudinal center axis thereof, and/or that the piston is connected fixedly and rigidly, but optionally releasably and separably, to the connecting rod via a connecting part, preferably in the form of a hollow screw, wherein the oil supply line opens into a recess of the connecting part, said recess, in the head region of the connecting part, having at least one discharge opening which opens into the cavity or the channels forming the cavity.

For a simple construction of the conducting of the oil, it is advantageously provided that a connection bore is formed in the connecting rod at a distance from the piston, said connection bore leading from the surface of the connecting rod radially with respect to the centrally situated oil supply line, and/or that the oil supply line is guided or extended in the connecting rod as far as the piston-remote end region thereof and is continued from there via a transfer channel into the interior space of a transverse bearing.

Simple production and a stable construction of the piston arise if the connecting rod is connected in terms of drive to a crankshaft, wherein the connecting rod is connected on the crankshaft side to a transverse bearing for a sliding block, the sliding block is mounted so as to be movable to and fro in the transverse bearing, and if a rolling bearing for receiving the crankshaft journal of the crankshaft is arranged in the sliding block and/or the transverse bearing and the connecting rod are formed as a single piece or from one part, in particular a precision casting, and/or if the transverse bearing or the bearing recess thereof has a rectangular inside cross section, optionally with inside corners having a rounded profile.

For the formation of the sliding bearing, it is advantageous if the sliding block is formed in two parts, and the two parts surround the rolling bearing, preferably a needle bearing, for the crankshaft journal, or if the sliding block is formed as a single part and the rolling bearing has a filling groove and is threaded onto the crankshaft journal and/or the sliding block is guided displaceably on rollers in the transverse bearing in a direction transversely with respect to the cylinder longitudinal axis.

It has been shown in practice that it is advantageous for the passage of oil through the sliding bearing if the transfer channel opens into a bearing recess enclosed by the transverse bearing, and/or if at least one bore is formed in the sliding block, said bore passing through the sliding block between the opposite wall surfaces thereof, and/or if a depression lying opposite the connecting rod is formed in the piston-close wall surface of the sliding block, into the region of which recess the transfer channel opens, which depression has at least one transverse extent which corresponds to the offset of the sliding block during the movement thereof to and fro. The oil which is used for cooling purposes and leaves the piston can therefore be directly used for lubricating the connection of the connecting rod to the crankshaft, namely the sliding bearing connecting the connecting rod to the crankshaft.

For the interaction of a cylinder and an engine piston for the construction of an engine, it is advantageous if that side of the transverse bearing which is opposite the piston is connected to a further connecting rod, wherein the two connecting rods are preferably oriented coaxially and the further connecting rod is connected rigidly to a further piston. The operating reliability is increased if the sliding block and the transverse bearing are fixed in a plane by a guide unit and are secured against mutual rotation about the piston axis.

In an advantageous embodiment of a cylinder according to the invention, it is provided that the combustion-chamber-remote base region of the cylinder has a guide in which the connecting rod is mounted in a guided manner and/or the guide seals the cylinder or the combustion-chamber-remote end thereof, in particular in a gastight manner.

A structurally simple construction is produced if an oil supply line for the connecting rod is formed in the guide, said oil supply line extending along the guide path and parallel to the direction of movement of the connecting rod and communicating with the connection bore at least over half the piston travel beginning at the upper dead center of the piston, and/or at least one groove, in which an inwardly sealing metallic oil scraper ring for the connecting rod is arranged, is formed in the guide and/or the inlet opening of an oil return channel opens into the wall surface of the guide on the combustion-chamber-remote side of the oil scraper ring, said oil return channel sloping or being inclined downward in the use position of the cylinder and having a vertical component, the other end of which oil return channel is led into the crankcase. This results in gravitational conveying of the cooling oil.

Depending on the intended purpose, it is possible that the slider crank is arranged offset in relation to the connecting rod, and the connecting rod emerges from the transverse bearing at a distance from the longitudinal center plane thereof, and/or the slider crank is formed in an offset manner and the transverse center plane of the transverse bearing encloses an angle of 84° to 89°, preferably 85 to 89°, with the connecting rod and/or preferably in the case of a 2-stroke cylinder, a heat exchanger for charge air cooling is arranged in the precompression chamber below the piston, said heat exchanger advantageously being supported by the guide or by a component forming the latter.

In the case of an opposed piston engine according to the invention comprising two cylinders assembled to form a cylinder, it is provided that a piston which is connected to a crankshaft is mounted in said cylinders, wherein the cylinders are connected to each other by the combustion-chamber-side end regions thereof, preferably the end surfaces of the cylinder wall, and are advantageously formed as a single piece or part.

The invention furthermore relates to an engine, in particular a 180° V-engine, comprising two cylinders, each comprising a piston with a connecting rod and with a transverse bearing, wherein the two cylinders are arranged on either side of the crankshaft, and the connecting rod of each cylinder is connected, preferably integrally, to the transverse bearing situated on the crankshaft journal.

Other features which are considered as characteristic for the invention are set forth in the appended claims.

Although the invention is illustrated and described herein as embodied in a piston crown precision cooling, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows, in a schematic section, a cylinder comprising a piston which is arranged therein and a bearing connection with a sliding bearing, which is connected to the piston via a connecting rod, for a crankshaft.

FIG. 2 shows a transverse bearing which lies between a connecting rod and a crankshaft, wherein the connecting rod and piston are also connected with the aid of a connecting screw.

FIG. 3 shows a schematic view of a bearing connection with connecting rod and transverse bearing, which are manufactured from a single component.

FIG. 4 shows a schematic section through an opposed piston engine according to the invention.

FIG. 5 shows a means for securing against rotation or a guide unit for a sliding block of a transverse bearing.

FIG. 6 shows schematically a 180° V-engine.

FIG. 7 shows schematically a 4-cylinder star arrangement with two 180° V-engines.

FIG. 8 shows an offset slider crank.

FIG. 9 shows an inclined slider crank.

FIGS. 10 and 11 show detailed views of a piston.

FIG. 12 shows a cylinder with a charge air cooler.

### DETAILED DESCRIPTION OF THE INVENTION

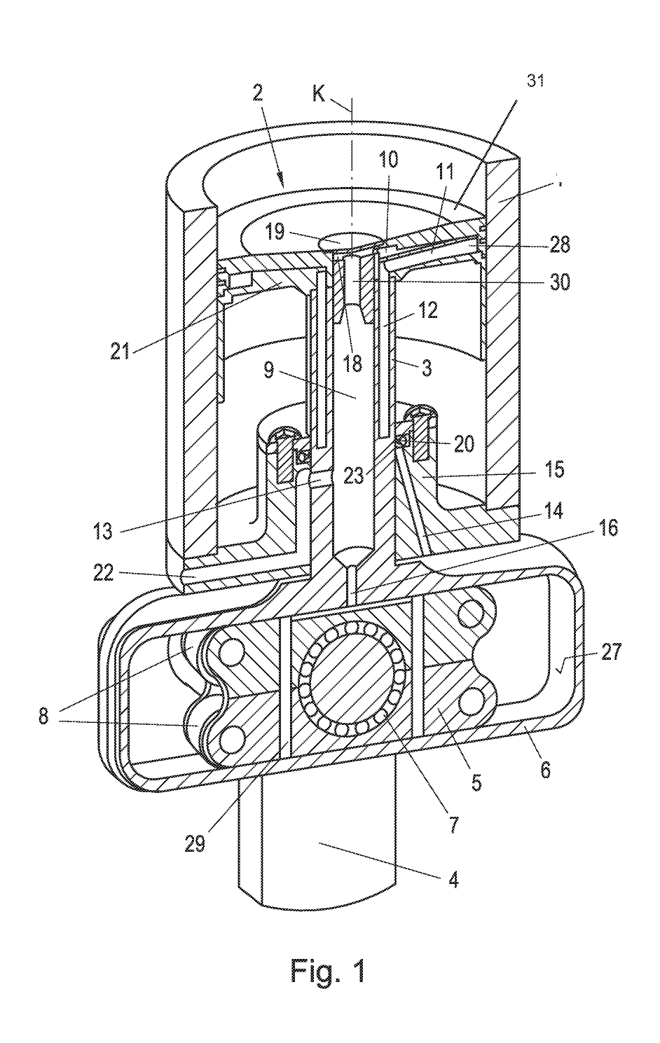

FIG. 1 illustrates, in a schematic section, an engine cylinder 1, the combustion chamber of which can be closed by a cylinder head (not illustrated) in which ignition units and/or units for introducing fuel and/or fuel/air mixtures can be arranged. A guide 15 is formed in the combustion-chamber-remote end region of the cylinder 1, said guide closing off the volume of the cylinder 1 that is remote from the combustion chamber and being connected to the cylinder wall and at the same time guiding a connecting rod 3, which is connected rigidly to a piston 2. Connecting rod 3 and piston 2 can be releasably connected to a connecting part 19 which is formed by a head or hollow screw and has an oil guide 30 and at least one oil discharge opening 18. In the combustion-chamber-remote end region thereof, the connecting rod 3 bears a transverse bearing 6, in which a sliding block 5 is mounted displaceably perpendicularly to the axis of the connecting rod 3. Said sliding block 5 is mounted displaceably by means of rollers 8 in a bearing recess 27 of the transverse bearing 6. The sliding block 5 is designed in two parts, wherein the two parts can be connected fixedly to each other by means of screws 17. A rolling bearing 7, advantageously a needle bearing, for receiving a crankshaft journal 24 of a crankshaft 4 is arranged in the sliding block 5.

The connecting rod 3 contains an oil supply line 9 which is connected via a connection bore 13 to an oil supply line 22 coming from the crankshaft housing or an oil sump, which oil supply line 22 is guided by the guide 15. Starting from the region of the upper dead center, the oil supply line 22 and the connection bore 13 communicate over a certain stroke distance, and therefore oil can be conveyed into the oil supply line 9. In the present case, an oil supply line 22 is formed in the guide 15 along the guide path for the connecting rod 3, said oil supply line communicating with the connection bore 13 at least over half of the piston travel to and from the upper dead center of the piston 2.

The oil supply line 9 is located centrally in the connecting rod 3 and is continued in the connecting and holding part 19 which is inserted into the connecting rod 3 and is situated in the center of the piston 2. Said connecting and holding part 19 serves firstly for forming oil conducting channels, as explained below. Secondly, said holding and connecting part 19 also serves to configure the connection of piston 2 and connecting rod 3 to be rigid and fixed, but in particular also to be separable and releasable. The connecting and holding part 19 which extends the oil supply line 9 through the connecting rod 3 by means of a central recess has discharge openings 18 with which the supplied oil can be supplied to cavities 10 or to cavities 10 formed by channels, which cavities 10 are formed in the piston head of the piston 2. During the braking of the piston 2 as the piston 2 approaches the upper dead center, oil located in the oil supply line 9 is pressed into the cavities 10 through the connecting and holding part 19 and the discharge openings 18. Said oil flows via annular or reversing chambers 28, which are formed peripherally in the piston head 21, and in return lines 11, which are likewise formed in the piston head 21, and from said return lines 11 into at least one oil return line 12 which is formed in the connecting rod 3.

The cavities 10 or the channels forming said cavities 10 run from the connecting rod 3 or from the connecting and holding part 19 in a slightly rising manner at an angle W with respect to the circumference of the piston 2. The reversing chambers 28 are formed by cavities or channels located peripherally. The return lines 11 returning from said reversing chambers 28 to the connecting rod 3 are likewise formed in an inclined manner, but the openings of the return lines 11 into the reversing chamber 28 and into the oil return line 12 are located further away from the combustion chamber or from the combustion-chamber-side piston surface 31 than the connections of the cavities 10 to the holding part 19 and to the reversing chamber 28.

It is expedient if the cavity 10 or the channels forming the cavity 10 and/or the return line 11 are inclined at an angle W of 1° to 4°, preferably 1° to 3°, to a plane perpendicular to the piston longitudinal axis K, wherein the peripheral end of the cavity 10 or of the channels forming the cavity 10 lies closer to the combustion-chamber-side piston surface 31 than the return line 11.

At least one groove 23, in which an inwardly sealing metallic oil scraper ring 20 for the connecting rod 3 is arranged, is formed in the guide 15, wherein the inlet opening 14′ of an oil return channel 14 adjoins or opens out in the surface of the guide 15 on the combustion-chamber-remote side of the oil scraper ring 20, the other end of which oil return channel is led into the crankcase. The oil return channel 14 is guided in the guide 15 or in the cylinder 1 in such a manner that said oil return channel is directed downward in the use position of the cylinder 1 and permits oil to be returned by gravity.

At the end region thereof which is remote from the combustion chamber, the oil supply line 9 formed in the connecting rod 3 has a transfer channel 16 which opens into the bearing recess 27 of the transverse bearing 6 in order to lubricate the sliding block 5. The movement of the sliding block 5 and of the rollers 8 to and fro in the bearing recess 27 is therefore pressure-lubricated. By means of the braking of the piston 2 as the latter approaches the lower dead center thereof, oil is pressed on account of the mass inertia in the oil supply line 9 through the transfer channel 16 into the bearing recess 27.

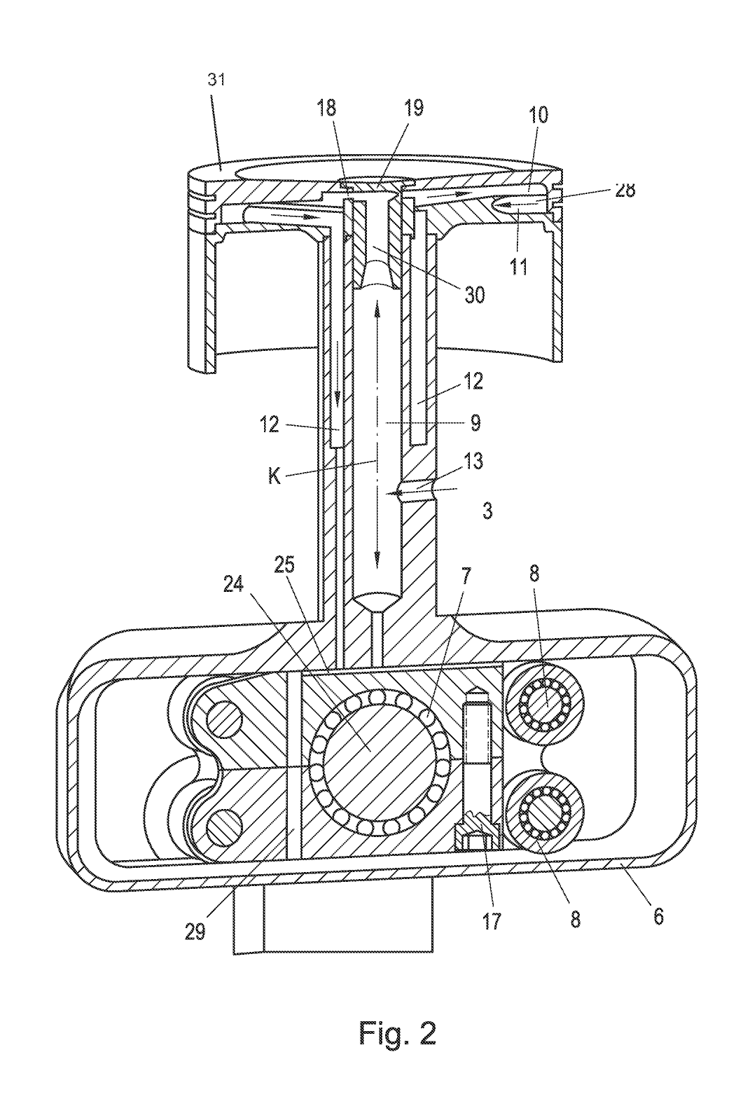

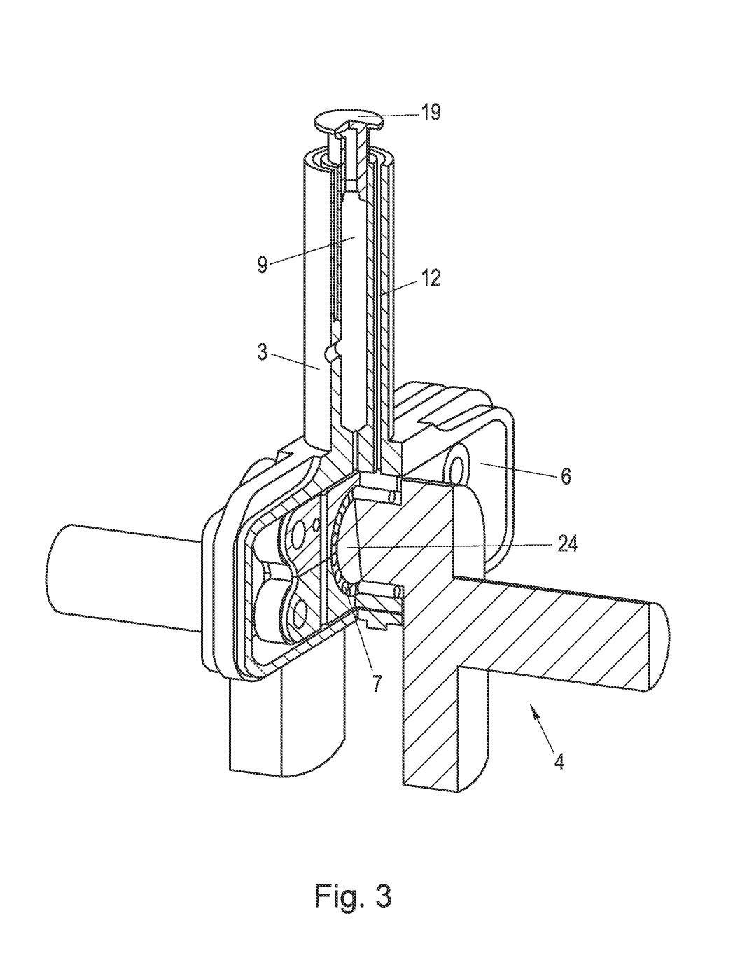

As can be gathered from FIG. 2, the transverse bearing 6 or the bearing recess 27 thereof has a rectangular inside cross section, optionally with inside corners having a rounded profile. Furthermore, it is apparent from FIG. 3 that the oil return line 12 opens directly into the bearing recess 27 via the transfer channel 16.

The mounting of the crankshaft journal 24 in the needle bearing 7 of the sliding block 5 can be gathered from FIGS. 2 and 3. It can also be gathered from these two Figs. that the oil return line 12 in the connecting rod 3 is designed in the form of parts of a cylinder ring.

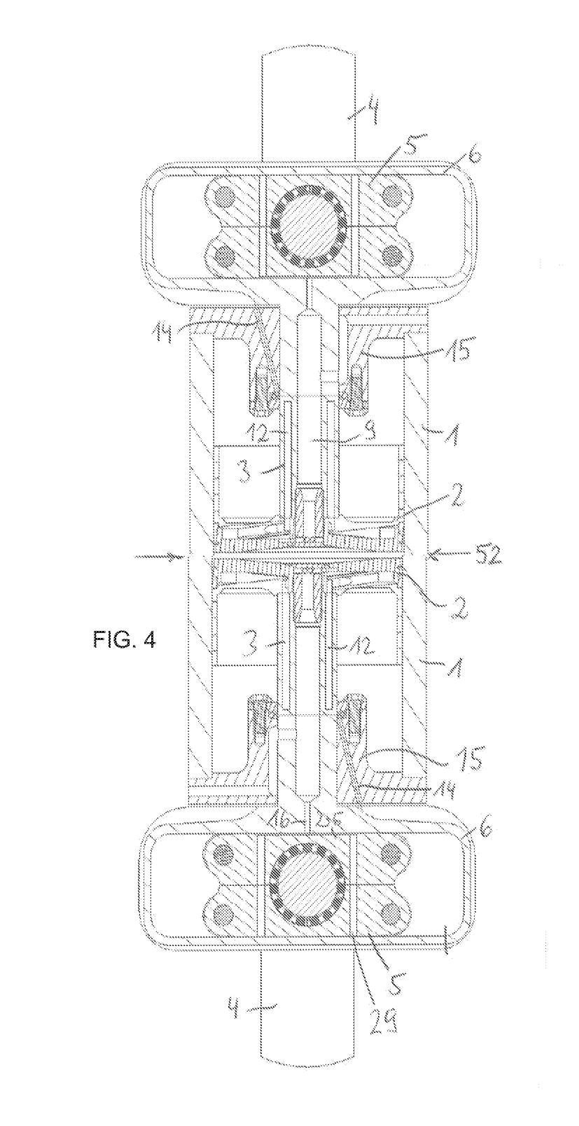

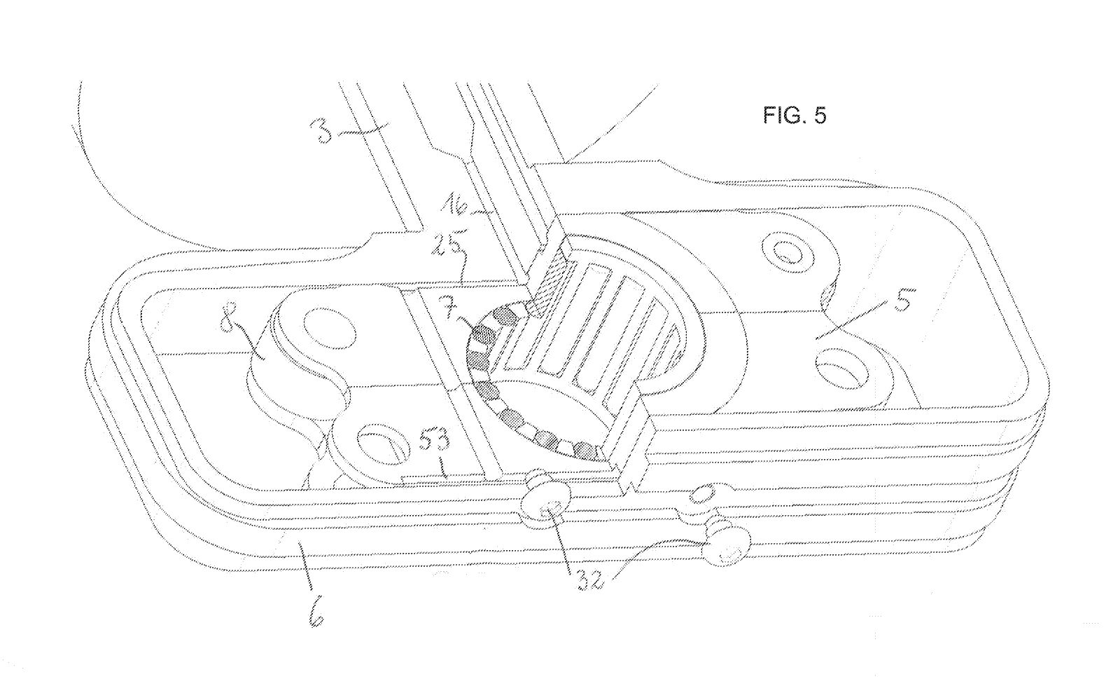

FIG. 4 shows a section through an opposed piston engine according to the invention comprising pistons and cylinders according to the invention. Said opposed piston engine is constructed so as, for the most part, to be symmetrical or mirror-inverted with respect to a center plane 52 and with cylinders which are rotated through 180°. The opposed piston engine comprises two cylinders 1 according to the invention, which are connected to each other by the combustion-chamber-side circumferential walls thereof. In principle, a cylinder of this type could also be formed as a single piece. Two pistons 2 according to the invention, to each of which a connecting rod 3 is rigidly fastened, are arranged in the cylinder 1. The connecting rods 3 are guided in guides 15 which are connected to the cylinder at the two ends thereof which are remote from the combustion chamber or close off said ends. Transverse bearings 6 are integrally formed on the connecting rods 3, in each of which transverse bearings a sliding block 5 is mounted so as to be movable to and fro, and the crankshaft 4 is mounted together with the crankshaft journal 24 in said sliding block. In the present case, apart from the oil return channels 14, the construction of the opposed piston motor according to the invention is symmetrical with respect to the center plane 52.

The sliding block 5 may also be placed onto crankshafts 4 formed as a single part, by the rolling bearing 7 being selected to be of a corresponding size or having a groove for the insertion of the rolls after the sliding block 5 has been placed onto the respective rocker arm or the crankshaft journal 24.

The sliding block 5 and the transverse bearing 6 can be fixed in a plane by a guide unit 53, 32 and secured against mutual rotation about the piston axis K. For the angularly fixed connection of the sliding block 5 and transverse bearing 6 and of the crankshaft journal 24 and piston 2, a groove 53 may be formed in the combustion-chamber-remote sliding surface of the sliding block 5, into which groove it is possible to fit or screw at least one bolt or journal or profiled part 32 which is inserted through the preferably combustion-chamber-remote wall part of the transverse bearing 6, protrudes into the groove 53 and guides the sliding block 5 with respect to the transverse bearing 6. It is also possible to use a plurality of such guides 32 or guides on both sides of the piston axis K. By forming such a means of axially securing against rotation, it can be avoided that the transverse bearing 6 comes into contact with the crankshaft 4 or the rocker arm 24 during operation. It is also possible to insert into the transverse bearing 6 profiled parts which are configured differently than the profiled parts illustrated, for example a plate-like piece which is held by securing screws and protrudes into the groove 53.

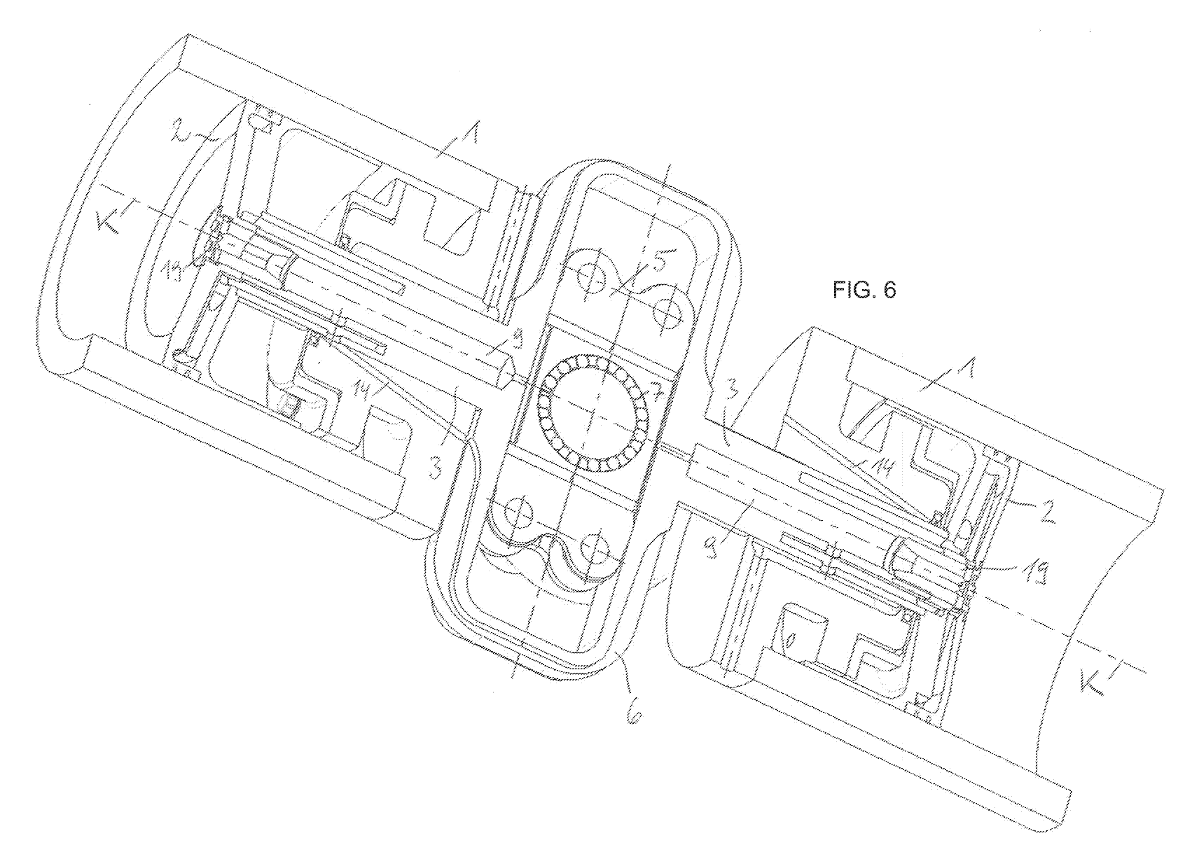

FIG. 6 shows an embodiment of an engine, in which two cylinders 1 which are of identical configuration and in particular are rotated through 180° with respect to each other, are arranged, wherein the two connecting rods of the pistons 2 arranged in each case in the cylinders 1 are connected to one and the same transverse bearing 6. That connection advantageously follows in such a manner that the connecting rods 3 and the transverse bearing 6 are manufactured from a single part, in particular precision casting. The two pistons 2 are driven in an opposed manner in the respective cylinders 1, and therefore the two pistons 2 simultaneously exert force in said direction on the transverse bearing 6 and therefore on the crankshafts 4. This produces a 180° V-engine.

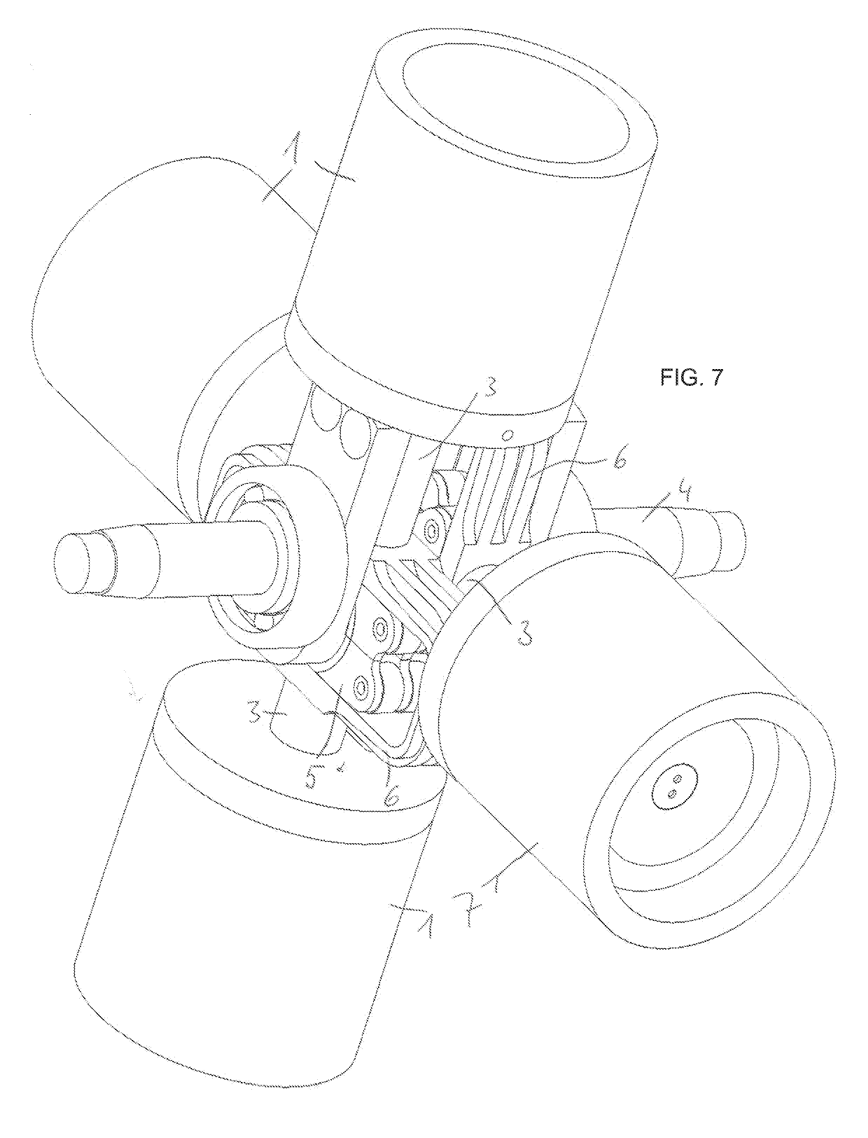

FIG. 7 shows an arrangement of cylinders 1 of an engine for driving a crankshaft 4. The cylinders 1 are each located in pairs opposite one another, and the connecting rods 3 of the respective pistons 2 lying opposite one another in pairs are each connected to a transverse bearing 6, in which the sliding block 5 is displaceable to and fro. This brings about the 4-cylinder star arrangement, which is illustrated in FIG. 7, of two 180° V-engines having a bank angle of 90°.

However, it is readily also possible to produce a double star arrangement, that is to say with two times four 180° V-engines, i.e. with a total of 8 cylinders. The bank angle between the individual engines can be selected depending on requirements.

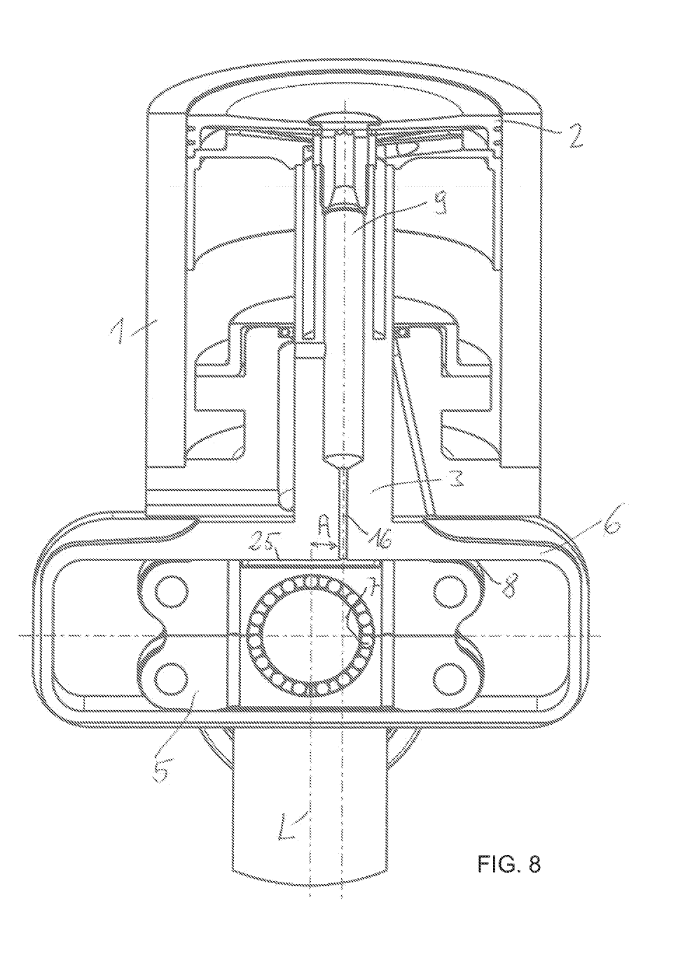

FIG. 8 shows an embodiment of a cylinder 1 with an offset crank slider 4. The crank slider 24 is offset relative to the connecting rod 3, and the axis of the connecting rod 3 lies at the distance A from the longitudinal center plane L of the transverse bearings 6, wherein the longitudinal center plane L is perpendicular to the direction of movement of the sliding block 5 and parallel to the piston axis K.

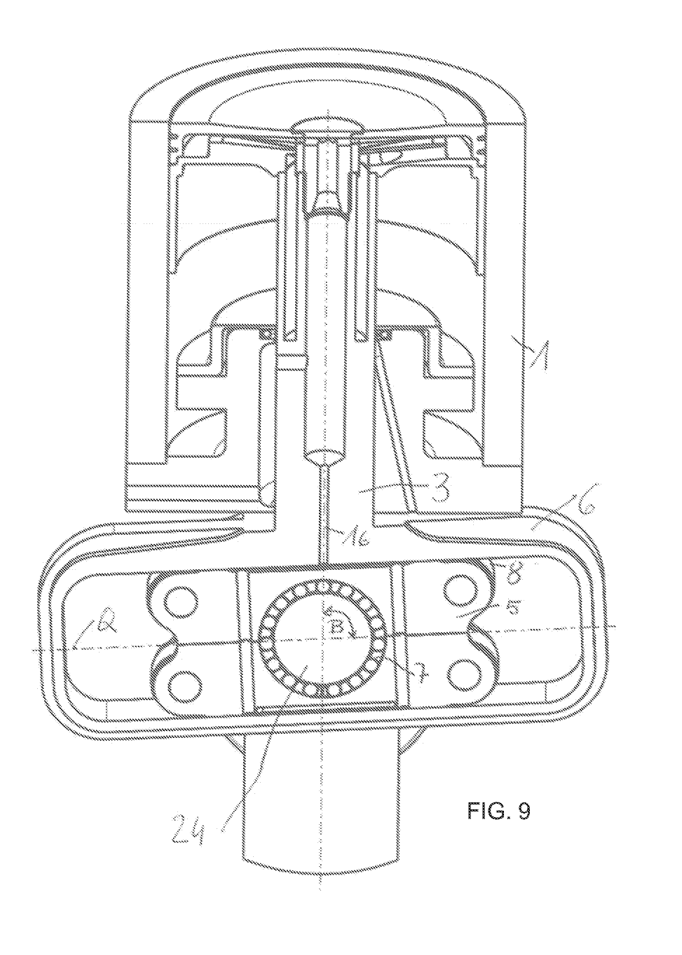

FIG. 9 shows an embodiment of a cylinder 1 with a transverse bearing 6 which is inclined with respect to the connecting rod 3. The crank slider 24 is formed in an inclined manner, and the transverse center plane Q of the transverse bearing 6 encloses an angle B of 84 to 89°, preferably 85 to 89°, with the connecting rod 3.

The angle B and the distance A are adapted to the particular intended use.

If the crank drive is designed in an offset manner in order to reduce the piston lateral force, the kinematics are improved and the bending moment in the region of the connecting rod bearing is reduced. In the event of an offset, the cylinder center line is advantageously offset by approximately 4 to 10% of the cylinder bore upstream of the crankshaft center line in the direction of rotation.

The transverse bearing 6 is advantageously formed with the connecting rod 3 as a component consisting of a single piece. In principle, it is also possible to connect, for example to weld and/or to screw, the connecting rod 3 to the transverse bearing 6.

The annular space 28 is advantageously continuously open and constitutes that region of the cavity 10 which is closest to the combustion chamber.

The crankshaft is advantageously designed as a single piece.

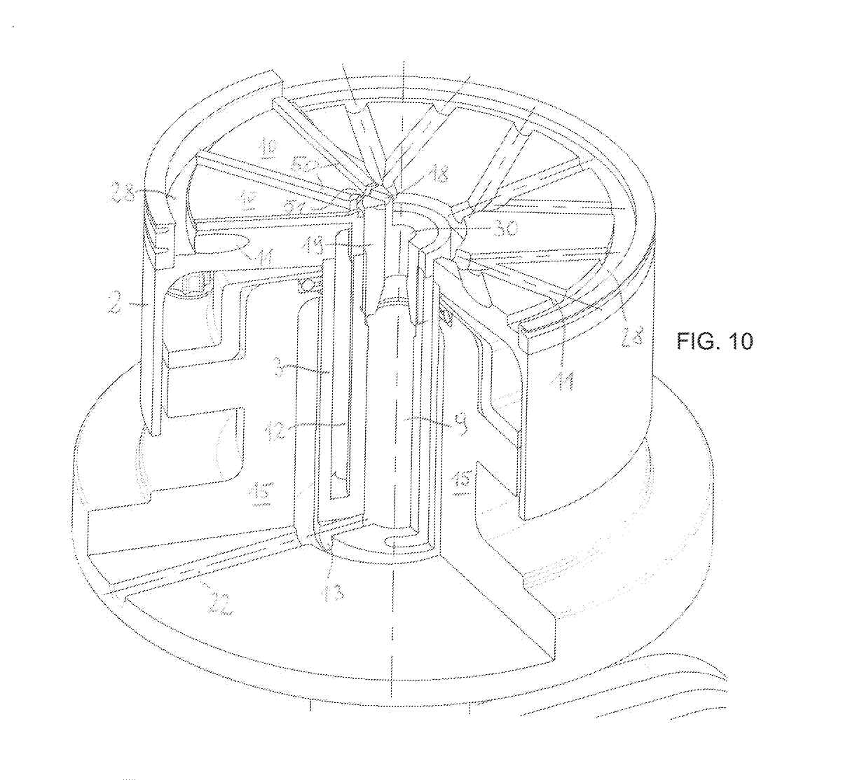

FIG. 10 shows a schematic sectional view of a piston 2, as can be used in a cylinder 1. The piston head has been omitted such that the cavities 10 and the return lines 11, which communicate with the peripherally encircling annular space 28, can be seen. The guide component 15 is tightly fitted to the rear wall or combustion-chamber-remote wall formation of the piston 2 in order to be able to compress the charge air if need be. The cavities 10 have an area in the shape of a sector of a circle and are separated by webs 50 which may optionally also limit the inflow openings 51 into the cavities 10 in a specific manner.

The volume and the cross sectional profile of the cavities 10 and of the return lines 11 are designed in a specific manner in order to influence the throughflow of oil.

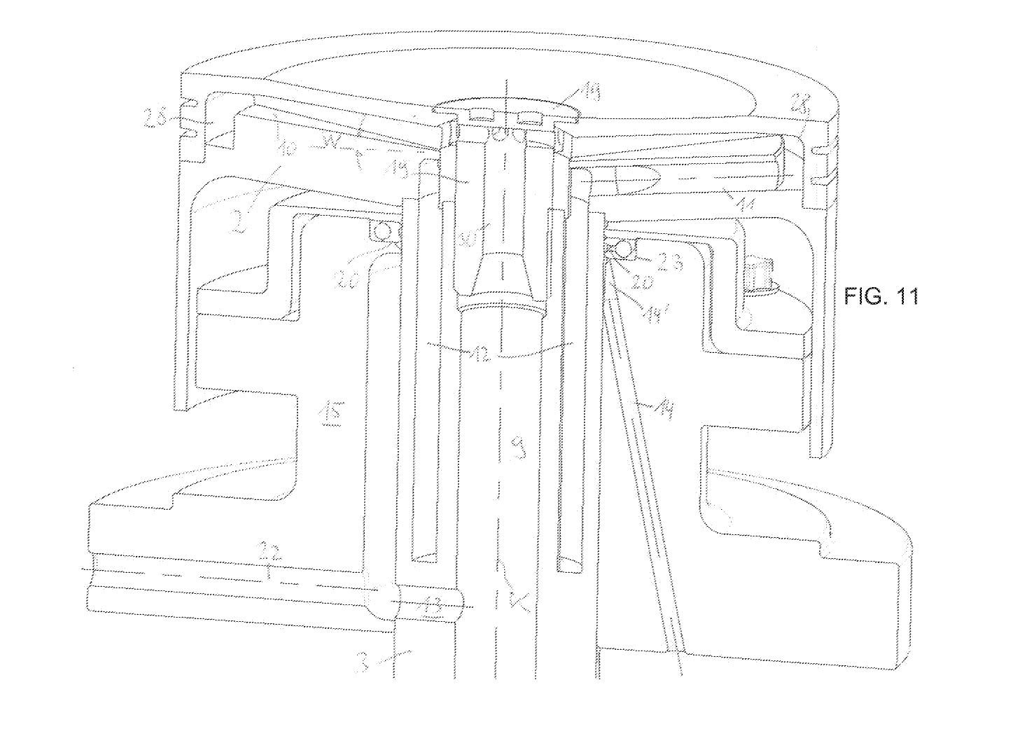

FIG. 11 shows a detailed view revealing the oil return channel 14 which runs in the guide 15 and the inlet opening 14′ of which opens into the guide space, in which the connecting rod 3 is mounted in a manner so as to be movable up and down. The angle of inclination W of the cavities 10 and of the return lines 11 with respect to the piston axis K is clearly visible.

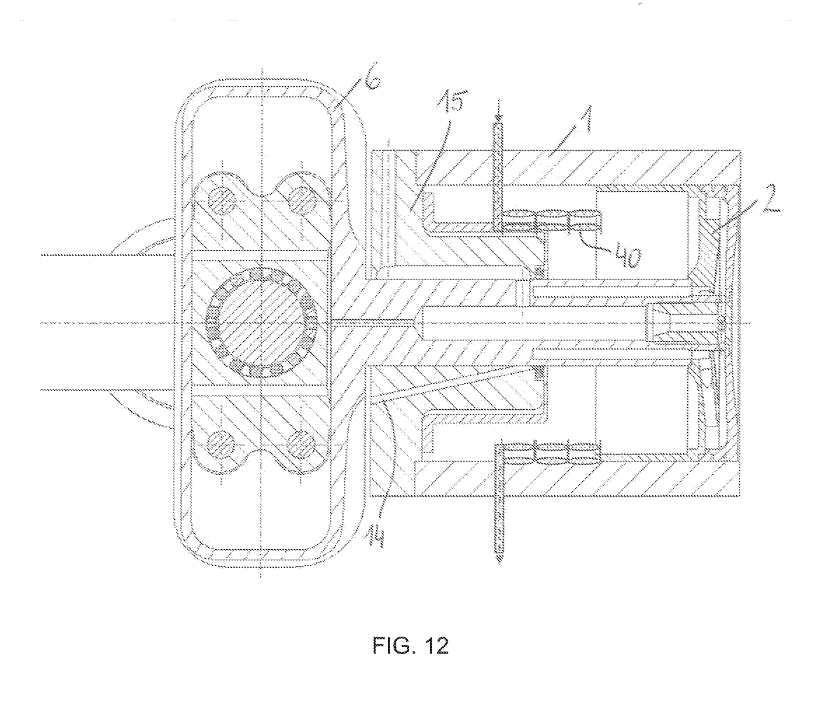

FIG. 12 shows a cylinder 1 in which a heat exchanger 40 is supported by the guide part 15. The heat exchanger 40 could also be arranged on or fastened to the wall of the cylinder 1. The heat exchanger 40 is located in the volume which is formed and is delimited by wall surfaces of the guide 15, of the cylinder 1 and the piston back wall and permits cooling of the charge air guided through said space. The heat exchanger 40 in said precompression space can be operated with engine oil as cooling liquid or with a coolant formed by water and glycol. The coolant circuit could be connected to the water cooling system of the engine cylinder. In the case of oil cooling, the cooling oil which is used for the cooling of the piston 2 could also be used as heat exchanger fluid. The operating temperatures of the cooling oil amount to approximately 120° to 140°, whereas the temperature of the water cooling system is kept low in a 2-stroke cylinder and is at approximately 55° C. to 80° C. Cooling of the heat exchanger 40 with water or a water/frost protection agent is therefore preferred, since water, in comparison to oil, also has a more favorable specific heat, and therefore more effective transporting away of heat is achieved. The guides for the charge air are not illustrated in FIG. 12.

1. An engine piston, comprising a connecting rod connected rigidly to the piston, wherein at least one cavity is formed in the piston head, said cavity communicating in the region thereof close to the piston longitudinal axis with an oil supply line running through the connecting rod, wherein the cavity is formed by a number of channels which run, preferably radially, in the piston head and are connected to one another in the circumferential region of the piston via an annular space or an annular line, and wherein a return line leading to the connecting rod is connected to the annular space or the annular line, wherein the cavity or the channels forming the cavity and/or the return line are inclined at an angle of 1° to 4°, preferably 1° to 3°, to a plane perpendicular to the piston longitudinal axis.

2. The piston as claimed in claim 1, wherein the cavity is formed by a number of channels which preferably run radially in the piston head, are optionally connected to one another, in particular in the circumferential region of the piston, preferably via an annular space or annular line, and/or branch in the piston head or are expanded toward the piston circumference.

3. The piston as claimed in claim 1, wherein the cavity or the channels forming the cavity are connected in the circumferential region of the piston, optionally via at least one annular or collecting line running peripherally, to at least one return line leading to the connecting rod, and/or in that the return line is connected to an oil return line guided in the connecting rod, and the cavity or the channels forming the cavity is or are located closer to the end surface of the piston than the return lines.

4. The piston as claimed in claim 1, wherein the oil supply line is guided centrally in the connecting rod, and/or in that the oil return line which is connected to the return line is arranged peripherally or eccentrically in the connecting rod.

5. The piston as claimed in claim 1, wherein the piston is formed centrally and symmetrically with respect to the longitudinal center axis thereof, and/or in that the piston is connected fixedly and rigidly, but optionally releasably and separably, to the connecting rod via a connecting part, preferably in the form of a hollow screw, wherein the oil supply line opens into a recess of the connecting part, said recess, in the head region of the connecting part, having at least one discharge opening which opens into the cavity or the channels forming the cavity.

6. The piston as claimed in claim 1, wherein a connection bore is formed in the connecting rod at a distance from the piston, said connection bore leading from the surface of the connecting rod radially with respect to the centrally situated oil supply line, and/or in that the oil supply line is guided or extended in the connecting rod as far as the piston-remote end region thereof and is continued from there via a transfer channel into the interior space of a transverse bearing.

7. The piston as claimed in claim 1, wherein the cavity or the channels forming the cavity and/or the return line are inclined at an angle of 1° to 4°, preferably 1° to 3°, to a plane perpendicular to the piston longitudinal axis, wherein the peripheral end of the cavity or of the channels forming the cavity is located closer to the combustion-chamber-side piston head surface than the return line.

8. The piston as claimed in claim 1, wherein the connecting rod is connected in terms of drive to a crankshaft, wherein the connecting rod is connected on the crankshaft side to a transverse bearing for a sliding block, the sliding block is mounted so as to be movable to and fro in the transverse bearing, and in that a rolling bearing for receiving the crankshaft journal of the crankshaft is arranged in the sliding block.

9. The piston as claimed in claim 8, wherein the transverse bearing and the connecting rod are formed as a single piece or from one part, in particular a precision casting, and/or in that the transverse bearing or the bearing recess thereof has a rectangular inside cross section, optionally with inside corners having a rounded profile.

10. The piston as claimed in claim 8, wherein the sliding block is formed in two parts, and the two parts surround the rolling bearing, preferably a needle bearing, for the crankshaft journal, or in that the sliding block is formed as a single part and the rolling bearing has a filling groove and is threaded onto the crankshaft journal.

11. The piston as claimed in claim 8, wherein the sliding block is guided displaceably on rollers in the transverse bearing in a direction transversely with respect to the cylinder longitudinal axis.

12. The piston as claimed in claim 8, wherein the transfer channel opens into a bearing recess enclosed by the transverse bearing, and/or in that at least one bore is formed in the sliding block, said bore passing through the sliding block between the opposite wall surfaces thereof, and/or in that a depression lying opposite the connecting rod is formed in the piston-close wall surface of the sliding block, into the region of which recess the transfer channel opens, which depression has at least one transverse extent which corresponds to the offset of the sliding block during the movement thereof to and fro.

13. The piston as claimed in claim 8, wherein that side of the transverse bearing which is opposite the piston is connected to a further connecting rod, wherein the two connecting rods are preferably oriented coaxially and the further connecting rod is connected rigidly to a further piston.

14. The piston as claimed in claim 8, wherein the sliding block and the transverse bearing are fixed in a plane by a guide unit and are secured against mutual rotation about the piston axis.

15. A cylinder comprising a connecting rod and a piston as claimed in claim 1, wherein the combustion-chamber-remote base region of the cylinder has a guide in which the connecting rod is mounted in a guided manner.

16. The cylinder as claimed in claim 15, wherein the guide seals the cylinder or the combustion-chamber-remote end thereof, in particular in a gastight manner.

17. The cylinder as claimed in claim 15, wherein an oil supply line for the connecting rod is formed in the guide, said oil supply line extending along the guide path and parallel to the direction of movement of the connecting rod and communicating with the connection bore at least over half the piston travel to and from the upper dead center of the piston.

18. The cylinder as claimed in claim 15, wherein at least one groove, in which an inwardly sealing metallic oil scraper ring for the connecting rod is arranged, is formed in the guide.

19. The cylinder as claimed in claim 18, wherein the inlet opening of an oil return channel opens in the wall surface of the guide on the combustion-chamber-remote side of the oil scraper ring, the other end of which oil return channel is guided in a sloping manner or, in the use position of the cylinder, following gravity into the crankcase.

20. The cylinder as claimed in claim 15, wherein the slider crank is arranged offset in relation to the connecting rod, and the connecting rod emerges from the transverse bearing at a distance from the longitudinal center plane thereof.

21. The cylinder as claimed in claim 15, wherein the slider crank is formed in an offset manner and the transverse center plane of the transverse bearing encloses an angle of 84° to 89°, preferably 85 to 88°, with the connecting rod.

22. The cylinder as claimed in claim 15, wherein, preferably in the case of a two-stroke cylinder, a heat exchanger for charge air cooling is arranged in the precompression chamber below the piston, said heat exchanger advantageously being supported by the guide or by a component forming the latter.

23. An opposed piston engine, comprising two cylinders assembled to form a cylinder as claimed in claim 15, each having a piston as claimed in claim 1 mounted therein, said piston being connected in each case by a sliding bearing to a crankshaft, wherein the cylinders are connected to each other by the combustion-chamber-side end regions thereof, preferably by the end surfaces of the cylinder wall, and are advantageously formed as a single piece or single part.

24. An engine, in particular a 180° V-engine, comprising two cylinders as claimed in claim 15, each having a piston as claimed in claim 1 with a connecting rod and with a sliding bearing, wherein the two cylinders are arranged on either side of the crankshaft, and the connecting rod of each cylinder is connected, preferably integrally, to the transverse bearing which is situated on the crankshaft journal.
